(19) United States
(12) Patent Application Publication
(10) Pub. No.: US 2008/0152167 A1
(43) Pub. Date: Jun. 26, 2008

(54) Near-field vector signal enhancement

(75) Inventor: Jon C. Taenzer, Los Altos, CA (US)

Correspondence Address: THELEN REID BROWN RAYSMAN & STEINER LLP, P. O. BOX 640640, SAN JOSE, CA, 95164-0640, US

(73) Assignee: STEP Communications Corporation, San Jose, CA (US)

(21) Appl. No.: 11/645,019

(22) Filed: Dec. 22, 2006

(51) Int. Cl. H04B 15/00

(52) U.S. Cl. 381/94.2

(57) ABSTRACT

Near-field sensing of wave signals, for example for application in headsets and earsets, is accomplished by placing two or more spaced-apart microphones along a line generally between the headset and the user's mouth. The signals produced at the output of the microphones will disagree in amplitude and time delay for the desired signal—the wearer's voice—but will disagree in a different manner for the ambient noises. Utilization of this difference enables recognizing, and subsequently ignoring, the noise portion of the signals and passing a clean voice signal. A first approach involves a complex vector difference equation applied in the frequency domain that creates a noise-reduced result. A second approach creates an attenuation value that is proportional to the complex vector difference, and applies this attenuation value to the original signal in order to effect a reduction of the noise. The two approaches can be applied separately or combined.

### CROSS-REFERENCE TO RELATED APPLICATIONS

(Not Applicable)

### BACKGROUND OF THE INVENTION

1. Field of the Invention

The invention relates to near-field sensing systems.

2. Description of the Related Art

When communicating in noisy ambient conditions, a voice signal may be contaminated by the simultaneous pickup of ambient noises. Single-channel noise reduction methods are able to provide a measure of noise removal by using a-priori knowledge about the differences between voice-like signals and noise signals to separate and reduce the noise. However, when the “noise” consists of other voices or voice-like signals, single-channel methods fail. Further, as the amount of noise removal is increased, some of the voice signal is also removed, thereby changing the purity of the remaining voice signal—that is, the voice becomes distorted. Further, the residual noise in the output signal becomes more voice-like. When used with speech recognition software, these defects decrease recognition accuracy.

Array techniques attempt to use spatial or adaptive filtering to either: a) increase the pickup sensitivity to signals arriving from the direction of the voice while maintaining or reducing sensitivity to signals arriving from other directions, b) to determine the direction towards noise sources and to steer beam pattern nulls toward those directions, thereby reducing sensitivity to those discrete noise sources, or c) to deconvolve and separate the many signals into their component parts. These systems are limited in their ability to improve signal-to-noise ratio (SNR), usually by the practical number of sensors that can be employed. For good performance, large numbers of sensors are required. Further, null steering (Generalized Sidelobe Canceller or GSC) and separation (Blind Source Separation or BSS) methods require time to adapt their filter coefficients, thereby allowing significant noise to remain in the output during the adaptation period (which can be many seconds). Thus, GSC and BSS methods are limited to semi-stationary situations.

A good description of the prior art pertaining to noise cancellation/reduction methods and systems is contained in U.S. Pat. No. 7,099,821 by Visser and Lee entitled “Separation of Target Acoustic Signals in a Multi-Transducer Arrangement”. This reference covers not only at-ear, but also remote (off-ear) voice pick-up technologies.

Prior art technologies for at-ear voice pickup systems recently have been driven by the availability and public acceptance of wired and wireless headsets, primarily for use with cellular telephones. A boom microphone system, in which the microphone's sensing port is located very close to the mouth, long has been a solution that provides good performance due to its close proximity to the desired signal. U.S. Pat. No. 6,009,184 by Tate and Wolff entitled “Noise Control Device for a Boom Mounted Noise-canceling Microphone” describes an enhanced version of such a microphone. However, demand has driven a reduction in the size of headset devices so that a conventional prior art boom microphone solution has become unacceptable.

Current at-ear headsets generally utilize an omni-directional microphone located at the very tip of the headset closest to the user's mouth. In current devices this means that the microphone is located 3″ to 4″ away from the mouth and the amplitude of the voice signal is subsequently reduced by the 1/r spreading effect. However, noise signals, which are generally arriving from distant locations, are not reduced so the result is a degraded signal-to-noise ratio (SNR).

Many methods have been proposed for improving SNR while preserving the reduced size and more distant-from-the-mouth location of modern headsets. Relatively simple first-order microphone systems that employ pressure gradient methods, either as “noise canceling” microphones or as directional microphones (e.g. U.S. Pat. Nos. 7,027,603; 6,681,022; 5,363,444; 5,812,659; and 5,854,848) have been employed in an attempt to mitigate the deleterious effects of the at-ear pick-up location. These methods introduce additional problems: the proximity effect, exacerbated wind noise sensitivity and electronic noise, frequency response coloration of far-field (noise) signals, the need for equalization filters, and if implemented electronically with dual microphones, the requirement for microphone matching. In practice, these systems also suffer from on-axis noise sensitivity that is identical to that of their omni-directional brethren.

In order to achieve better performance, second-order directional systems (e.g. U.S. Pat. No. 5,473,684 by Bartlett and Zuniga entitled “Noise-canceling Differential Microphone Assembly”) have also been attempted, but the defects common to first-order systems are also greatly magnified so that wind noise sensitivity, signal coloration, electronic noise, in addition to equalization and matching requirements, make this approach unacceptable.

Thus, adaptive systems based upon GSC, BSS or other multi-microphone methods also have been attempted with some success (see for example McCarthy and Boland, “The Effect of Near-field Sources on the Griffiths-Jim Generalized Sidelobe Canceller”, Institution of Electrical Engineers, London, IEE conference publication ISSN 0537-9989, CODEN IECPB4, and U.S. Pat. Nos. 7,099,821; 6,799,170; 6,691,073; and 6,625,587). Such systems suffer from increased complexity and cost, multiple sensors requiring matching, slow response to moving or rapidly changing noise sources, incomplete noise removal and voice signal distortion and degradation. Another drawback is that these systems operate only with relatively clean (positive SNR) input signals, and actually degrade the signal quality when operating with poor (negative SNR) input signals. The voice degradation often interferes with Automatic Speech Recognition (ASR), a major application for such headsets.

Another, multi-microphone noise reduction technology applicable to headsets is disclosed by Luo, et al. in U.S. Pat. No. 6,668,062 entitled “FFT-based Technique for Adaptive Directionality of Dual Microphones”. In this method, developed for use in hearing aids, two microphones are spaced approximately 10-cm apart within a behind-the-ear or BTE hearing aid case. The microphone input signals are converted to the frequency domain and an output signal is created using the equation

$$Z ( ω ) = X ( ω ) - X ( ω ) \times \frac{\vert Y ( ω ) \vert}{\vert X ( ω ) \vert} \qquad ( 1 )$$

where X(ω), Y(ω) and Z(ω) are the frequency domain transforms of the time domain input signals x(t) and y(t), and the time domain output signal z(t). In hearing aids the goal is to help the user to clearly hear the conversations of other individuals and also to hear environmental sounds, but not to hear the user him/herself. Thus, this technology is designed to clarify far-field sounds. Further, this technology operates to produce a directional sensitivity pattern that “cancels noise . . . when the noise and the target signal are not in the same direction from the apparatus”. The downsides are that this technology significantly distorts the desired target signal and requires excellent microphone array element matching.

Others have developed technologies specifically for near-field sensing applications. For example, Goldin (U.S. Publication No. 2006/0013412 A1 and “Close Talking Autodirective Dual Microphone”, AES Convention, Berlin, Germany, May 8-11, 2004) has proposed using two microphones with controllable delay-&-add technology to create a set of first-order, narrow-band pick-up beam patterns that optimally steer the beams away from noise sources. The optimization is achieved through real-time adaptive filtering which creates the independent control of each delay using LMS adaptive means. This scheme has also been utilized in modern DSP-based hearing aids. Although essentially GSC technology, for near-field voice pick-up applications this system has been modified to achieve non-directional noise attenuation. Unfortunately, when there is more than a single noise source at a particular frequency, this system can not optimally reduce the noise. In real situations, even if there is only one physical noise source, room reverberations effectively create additional virtual noise sources with many different directions of arrival, but all having the identical frequency content thereby circumventing this method's ability to operate effectively. In addition, by being adaptive, this scheme requires substantial time to adjust in order to minimize the noise in the output signal. Further, the rate of noise attenuation vs. distance is limited and the residual noise in the output signal is highly colored, among other defects.

### BRIEF SUMMARY OF THE INVENTION

In accordance with one embodiment described herein, there is provided a voice sensing method for significantly improved voice pickup in noise applicable for example in a wireless headset. Advantageously it provides a clean, non-distorted voice signal with excellent noise removal, wherein small residual noise is not distorted and retains its original character. Functionally, a voice pickup method for better selecting the user's voice signal while rejecting noise signals is provided.

Although discussed in terms of voice pickup (i.e. acoustic, telecom and audio), the system herein described is applicable to any wave energy sensing system (wireless radio, optical, geophysics, etc.) where near-field pick-up is desired in the presence of far-field noises/interferers. An alternative use gives superior far-field sensing for astronomy, gamma ray, medical ultrasound, and so forth.

Benefits of the system disclosed herein include an attenuation of far-field noise signals at a rate twice that of prior art systems while maintaining flat frequency response characteristics. They provide clean, natural voice output, highly reduced noise, high compatibility with conventional transmission channel signal processing technology, natural sounding low residual noise, excellent performance in extreme noise conditions—even in negative SNR conditions—instantaneous response (no adaptation time problems), and yet demonstrate low compute power, memory and hardware requirements for low cost applications.

Acoustic voice applications for this technology include mobile communications equipment such as cellular handsets and headsets, cordless telephones, CB radios, walkie-talkies, police and fire radios, computer telephony applications, stage and PA microphones, lapel microphones, computer and automotive voice command applications, intercoms and so forth. Acoustic non-voice applications include sensing for active noise cancellation systems, feedback detectors for active suspension systems, geophysical sensors, infrasonic and gunshot detector systems, underwater warfare and the like. Non-acoustic applications include radio and radar, astrophysics, medical PET scanners, radiation detectors and scanners, airport security systems and so forth.

The system described herein can be used to accurately sense local noises, so that these local noise signals can be removed from mixed signals that contain desired far-field signals, thereby obtaining clean sensing of the far-field signals.

Yet another use is to reverse the described attenuation action so that near-field voice signals are removed and only the noise is preserved. Then this resulting noise signal, along with the original input signals, can be sent to a spectral subtraction, Generalized Sidelobe Canceller, Weiner filter, Blind Source Separation system or other noise removal apparatus where a clean noise reference signal is needed for accurate noise removal.

The system does not change the purity of the remaining voice while improving upon the signal-to-noise-ratio (SNR) improvement performance of beamforming-based systems and it adapts much more quickly than do GSC or BSS methods. With these other systems, SNR improvements are still below 10-dB in most high noise applications.

### BRIEF DESCRIPTION OF THE SEVERAL VIEWS OF THE DRAWINGS

Many advantages of the present invention will be apparent to those skilled in the art with a reading of this specification in conjunction with the attached drawings, wherein like reference numerals are applied to like elements, and wherein:

FIG. 1 is a schematic diagram of a type of a wearable near-field audio pick-up device;

FIG. 1A is a block diagram illustrating a general pick-up process;

FIG. 2 is generalized block diagram of a system for accomplishing noise reduction;

FIG. 3 is a block diagram showing processing details;

FIG. 4 is a block diagram of a signal processing portion of a direct equation approach;

FIG. 5 shows on-axis sensitivity relative to the mouth sensitivity vs. distance from the headset;

FIG. 6 shows the attenuation response of a system at seven different arrival angles from 0° to 180°;

FIG. 7 is a plot of the directionality pattern of a system using two omni-directional microphones and measured at a source range of 0.13 m (5″);

FIG. 8 shows attenuation created by Equation (7) as a function of the magnitude difference between the front microphone signal and the rear microphone signal for the 3 dB design example;

FIG. 9 shows the attenuation characteristics produced by Equations (8) and (9) as compared with that produced by Equation (7);

FIG. 10 shows a block diagram of how an attenuation technique can be implemented without the need for the real-time calculation of Equation (7);

FIG. 11 shows a block diagram of a processing method employing full attenuation to the output signal;

FIG. 12 demonstrates a block diagram of a calculation approach for limiting the output to expected signals;

FIG. 13 is an example limit table;

FIGS. 14A and 14B show a set of limits plotted versus frequency;

FIG. 15 shows a graph of sensitivity as a function of the source distance away from the microphone array along the major axis and that of a prior art system; and

FIG. 16 shows the data of FIG. 15 graphed on a logarithmic distance scale to better demonstrate the improved performance.

### DETAILED DESCRIPTION OF THE INVENTION

Embodiments of the present invention are described herein in the context of near-field pick-up systems. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The system described herein is based upon the use of a controlled difference in the amplitude of two detected signals in order to retain, with excellent fidelity, signals originating from nearby locations while significantly attenuating those originating from distant locations. Although not constrained to audio and sound detection apparatus, presently the best application is in head worn headsets, in particular wireless devices known as Bluetooth® headsets.

Recognizing that energy waves are basically spherical as they spread out from a source, it can be seen that such waves originating from nearby (near-field) source locations are greatly curved, while waves originating from distant (far-field) source locations are nearly planar. The intensity of an energy wave is its power/unit area. As energy spreads out, the intensity drops off as 1/r², where r is distance from the source. Magnitude is the square root of intensity, so the magnitude drops off as 1/r. The greater the difference in distance of two detectors from a source, the greater is the difference in magnitude between the detected signals.

The system employs a unique combination of a pair of microphones located at the ear, and a signal process that utilizes the magnitude difference in order to preserve a voice signal while rapidly attenuating noise signals arriving from distant locations. For this system, the drop off of signal sensitivity as a function of distance is double that of a noise-canceling microphone located close to the mouth as in a high end boom microphone system, yet the frequency response is still zeroth-order—that is, inherently flat. Noise attenuation is not achieved with directionally so all noises, independent of arrival direction, are removed. In addition, due to its zeroth-order sensitivity response, the system does not suffer from the proximity effect and is wind noise-resistant, especially using the second processing method described below.

The system effectively provides an appropriately designed microphone array used with proper analog and A/D circuitry designed to preserve the signal “cues” required for the process, combined with the system process itself. It should be noted that the input signals are often “contaminated” with significant noise energy. The noise may even be greater than the desired signal. After the system's process has been applied, the output signal is cleaned of the noise and the resulting output signal is usually much smaller. Thus, the dynamic range of the input signal path should be designed to linearly preserve the high input dynamic range needed to encompass all possible input signal amplitudes, while the dynamic range requirement for the output path is often relaxed in comparison.

### Microphone Array

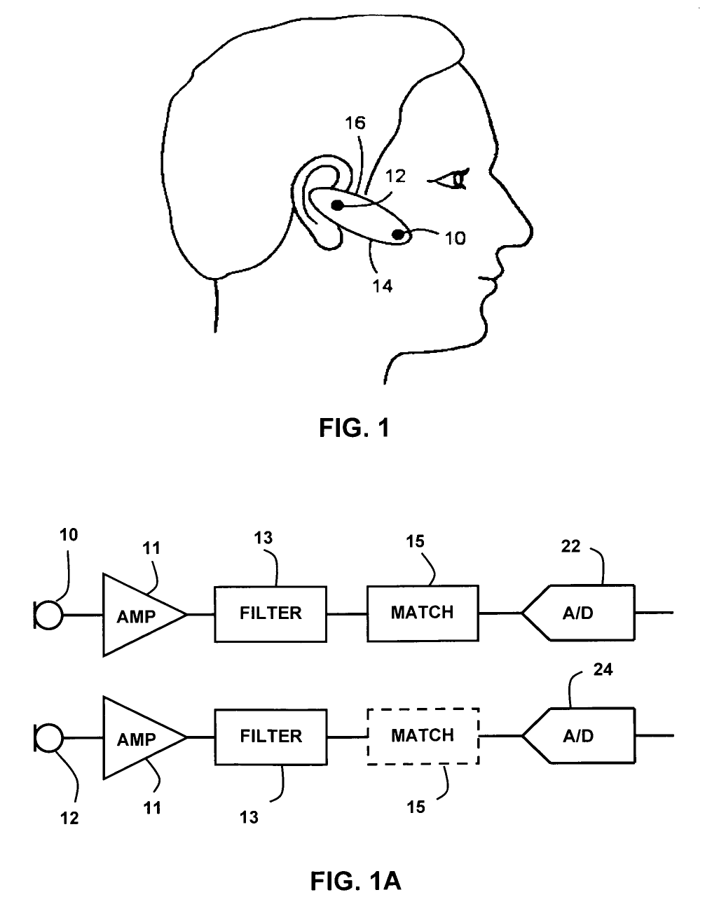

A microphone array formed of at least two separated microphones preferably positioned along a line (axis) between the headset location and the user's mouth—in particular the upper lip is a preferred target so that both oral and nasal utterances are detected—is shown in FIG. 1. Only two microphones are shown, but a greater number can be used. The two microphones are designated 10 and 12 and are mounted on or in a housing 16. The housing may have an extension portion 14. Another portion of the housing or a suitable component is disposed in the opening of the ear canal of the wearer such that the speaker of the device can be heard by wearer. Although the microphone elements 10 and 12 are preferably omni-directional units, noise canceling and uni-directional devices and even active array systems also may be compatibly utilized. When directional microphones or microphone systems are used, they are preferably aimed toward the user's mouth to thereby provide an additional amount of noise attenuation for noise sources located at less sensitive directions from the microphones.

The remaining discussion will focus primarily on two omni-directional microphone elements 10 and 12, with the understanding that other types of microphones and microphone systems can be used. For the remaining description, the microphone closest to the mouth—that is, microphone 10—will be called the “front” microphone and the microphone farthest from the mouth (12) the “rear” microphone.

In simple terms, using the example of two spaced apart microphones located at the ear of the user and on a line approximately extending in the direction of the mouth, the two microphone signals are detected, digitized, divided into time frames and converted to the frequency domain using conventional digital Fourier transform (DFT) techniques. In the frequency domain, the signals are represented by complex numbers. After optional time alignment of the signals, 1) the difference between pairs of those complex numbers is computed according to a mathematical equation, or 2) their weighted sum is attenuated according to a different mathematical equation, or both. Since in the system described herein there is no inherent restriction on microphone spacing (as long as it is not zero), other system considerations are the driving factors on the choice of the time alignment approach.

The ratio of the vector magnitudes, or norms, is used as a measure of the “noisiness” of the input data to control the noise attenuation created by each of the two methods. The result of the processing is a noise reduced frequency domain output signal, which is subsequently transformed by conventional inverse Fourier means to the time domain where the output frames are overlapped and added together to create the digital version of the output signal. Subsequently, D/A conversion can be used to create an analog output version of the output signal when needed. This approach involves digital frequency domain processing, which the remainder of this description will further detail. It should be recognized, however, that alternative approaches include processing in the analog domain, or digital processing in the time domain, and so forth.

Normalizing the acoustic signals sensed by the two microphones 10 and 12 to that of the front microphone 10, then the front microphone's frequency domain signal is, by definition, equal to “1.” That is,

\vec{S}_{f}(ω,θ,d,r)=1 (2)

where ω is the radian frequency, θ is the effective angle of arrival of the acoustic signal relative to the direction toward the mouth (that is, the array axis), d is the separation distance between the two microphone ports and r is the range to the sound source from the front microphone 10 in increments of d. Thus, the frequency domain signal from the rear microphone 12 is

$$\begin{matrix}{\overline{S}}_{r} ( ω , θ , d , r ) = {y}^{- 1} {e}^{- i ω rd ( y - 1 ) / c} , where & ( 3 ) \\ y = 1 + \frac{2}{r} cos ( θ ) + \frac{1}{{r}^{2}} , & ( 4 )\end{matrix}$$

c is the effective speed of sound at the array, and i is the imaginary operator \sqrt{−1}. The term rd(y−1)/c represents the arrival time difference (delay) of an acoustic signal at the two microphone ports. It can be seen from these equations that when r is large, in other words when a sound source is far away from the array, the magnitude of the rear signal is equal to “1”, the same as that of the front signal.

When the source signal is arriving on-axis from a location along a line toward the user's mouth (θ=0), the magnitude of the rear signal is

$$\vert {S}_{r} ( ω , θ , d , r ) \vert = {y}^{- 1} = \frac{r}{r + 1} \qquad ( 5 )$$

As an example of how this result is used in the design of the array, assume that the designer desires the magnitude of the voice signal to be 3 dB higher in the front microphone 10 than it is in the rear microphone 12. In this case,

$$\frac{r}{r - 1} = {10}^{- 3 / 20} = 0.708$$

and thus r=2.42. Therefore, the front microphone 10 should be located 2.42·d away from the mouth, and, of course, the rear microphone 12 should be located a distance d behind the front microphone. If the distance from the mouth to the front microphone 10 will be, for example, 12-cm (4¾-in) in a particular design, then the desired port-to-port spacing in the microphone array—that is the separation between the microphones 10 and 12—will be 4.96-cm (about 5-cm or 2-in). Of course, the designer is free to choose the magnitude ratio desired for any particular design.

### Microphone Matching

Some processing steps that may be initially applied to the signals from the microphones 10 and 12 are described with reference to FIG. 1A. It is advantageous to provide microphone matching, and using omni-directional microphones, microphone matching is easily achieved. Omni-directional microphones are inherently flat response devices with virtually no phase mismatch between pairs. Thus, any simple prior art level matching method suffices for this application. Such methods range from purchasing pre-matched microphone elements for microphones 10 and 12, factory selection of matched elements, post-assembly test fixture dynamic testing and adjustment, post-assembly mismatch measurement with matching “table” insertion into the device for operational on-the-fly correction, to dynamic real-time automatic algorithmic mismatch correction.

### Analog Signal Processing

As shown in FIG. 1A, analog processing of the microphone signals may be performed and typically consists of pre-amplification using amplifiers 11 to increase the normally very small microphone output signals and possibly filtering using filters 13 to reduce out-of-band noise and to address the need for anti-alias filtering prior to digitization of the signals if used in a digital implementation. However, other processing can also be applied at this stage, such as limiting, compression, analog microphone matching (15) and/or squelch.

The system described herein optimally operates with linear, undistorted input signals, so the analog processing is used to preserve the spectral purity of the input signals by having good linearity and adequate dynamic range to cleanly preserve all parts of the input signals.

### A/D-D/A Conversion

The signal processing conducted herein can be implemented using an analog method in the time domain. By using a bank of band-split filters, combined with Hilbert transformers and well known signal amplitude detection means, to separate and measure the magnitude and phase components within each band, the processing can be applied on a band-by-band basis where the multi-band outputs are then combined (added) to produce the final noise reduced analog output signal.

Alternatively, the signal processing can be applied digitally, either in the time domain or in the frequency domain. The digital time-domain method, for example, can perform the same steps and in the same order as identified above for the analog method, or may be any other appropriate method.

Digital processing can also be accomplished in the frequency domain using Digital Fourier Transform (DFT), Wavelet Transform, Cosine Transform, Hartley transform or any other means to separate the information into frequency bands before processing.

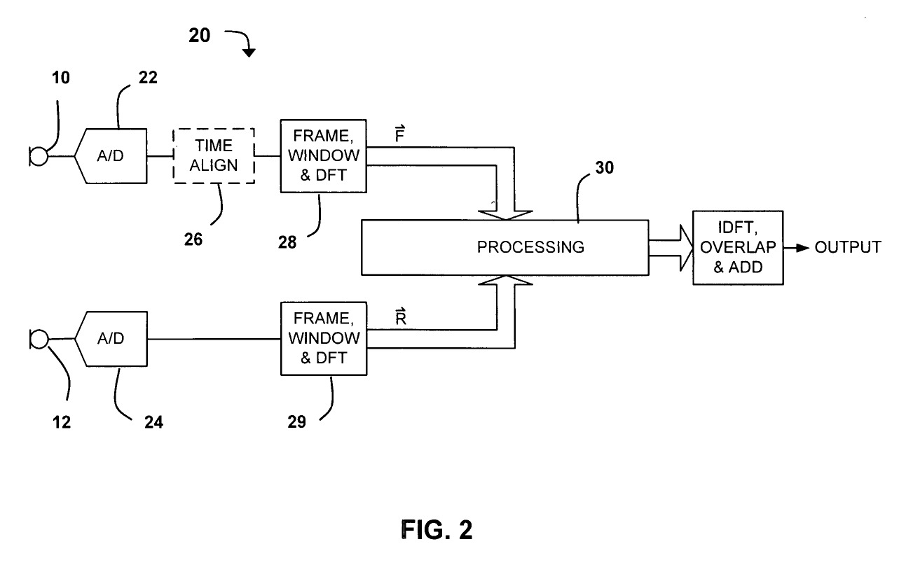

Microphone signals are inherently analog, so after the application of any desired analog signal processing, the resulting processed analog input signals are converted to digital signals. This is the purpose of the A/D converters (22, 24) shown in FIGS. 1A and 2—one conversion channel per input signal. Conventional A/D conversion is well known in the art, so there is no need for discussion of the requirements on anti-aliasing filtering, sample rate, bit depth, linearity and the like since standard good practices suffice.

After the noise reduction processing, for example by circuit 30 in FIG. 2, is complete, a single digital output signal is created. This output signal can be utilized in a digital system without further conversion, or alternatively can be converted back to the analog domain using a conventional D/A converter system as known in the art.

### Time Alignment

For the best output signal quality, it is preferable, but not required, that the two input signals be time aligned for the signal of interest—that is, in the instant example, for the user's voice. Since the front microphone 10 is located closer to the mouth, the voice sound arrives at the front microphone first, and shortly thereafter it arrives at the rear microphone 12. It is this time delay for which compensation is to be applied, i.e. the front signal should be time delayed, for example by circuit 26 of FIG. 2, by a time equal to the propagation time of sound as it travels around the headset from the location of the front microphone 10 port to the rear microphone 12 port. Numerous conventional methods are available for accomplishing this time alignment of the input signals including, but not limited to, analog delay lines, cubic-spline digital interpolation methods and DFT phase modification methods.

One simple means for accomplishing the delay is to select, during the headset design, a microphone spacing, d, that allows for offsetting the digital data stream from the front signal's A/D converter by an integer number of samples. For example, when the port spacing combined with the effective sound velocity at the in-situ headset location gives a signal time delay of, for example, 62.5 μsec or 125 μsec, then at a sample rate of 16 ksps the former delay can be accomplished by offsetting the data by one sample and in the latter delay can be accomplished by offsetting the data by two samples. Since many telecommunication applications operate at a sample rate of 8 ksps, then the latter delay can be accomplished with a data offset of one sample. This method is simple, low cost, consumes little compute power and is accurate.

### Overlap & Add Method

The processing may use the well known “overlap-and-add” method. Use of this method often may include the use of a window such as the Hanning or other window or other methods as are known in the art.

### Frequency Domain (Fourier) Transformation

One of the simplest and most common means for multi-band separation of signals in the frequency domain is the Short-Time Fourier Transform (STFT), and the Fast Fourier Transform (FFT) commonly is the digital implementation of choice. Although alternative means for multi-band processing are applicable as discussed above, a standard digital FFT/IFFT pair for transformation and processing approach is described herein.

FIG. 2 is a generalized block diagram of a system 20 for accomplishing the noise reduction with digital Fourier transform means. Signals from front (10) and rear (12) microphones are applied to A/D converters 22, 24. An optional time alignment circuit 26 for the signal of interest acts on at least one of the converted, digital signals, followed by framing and windowing by circuits 28 and 29, which also generate frequency domain representations of the signals by digital Fourier transform (DFT) means as described above. The two resultant signals are then applied to a processor 30, which operates based upon a difference equation applied to each pair of narrow-band, preferably time-aligned, input signals in the frequency domain. The wide arrows indicate where multiple pairs of input signals are undergoing processing in parallel. In the description herein it will be understood that the signals being described are individual narrow-band frequency separated “sub”signals wherein a pair is the frequency-corresponding subsignals originating from each of the two microphones.

First, each sub-signal of the pair is separated into its norm, also known as the magnitude, and its unit vector, wherein a unit vector is the vector normalized to a magnitude of “1” by dividing by its norm. Thus,

\vec{S}_{f}(ω,θ,d,r)=|S_{f}(ω,θ,d,r)|×Ŝ_{f}(ω,θ,d,r) (6)

where |S_{f}(ω,θ,d,r)| is the norm of \vec{S}_{f}(ω,θ,d,r), and Ŝ_{f}(ω,θ,d,r) is the unit vector of \vec{S}_{f}(ω,θ,d,r). Thus, all of the magnitude information about the input signal \vec{S}_{f} is in the norm, while all the angle information is in the unit vector. For the on-axis signals described above with respect to equations 2-4, |S_{f}(ω,θ,d,r)|=1 and Ŝ_{f}(ω,θ,d,r)=eⁱ⁰=1. Similarly,

\vec{S}ᵣ(ω,θ,d,r)=|Sᵣ(ω,θ,d,r)|×Ŝᵣ(ω,θ,d,r) (7)

and for the above signals, |Sᵣ(ω,θ,d,r)|=y⁻¹ and Ŝᵣ(ω,θ,d,r)=e^{iωrd(y-1)/c}.

The output signal from circuit 30, then, is

$$\begin{matrix}\vec{O} ( ω , θ , d , r ) = ( \vert {S}_{f} ( ω , θ , d , r ) \vert - \vert {S}_{r} ( ω , θ , d , r ) \vert ) \times \\ ( {\hat{S}}_{f} ( ω , θ , d , r ) + {\hat{S}}_{r} ( ω , θ , d , r ) ) \\ = ( 1 - {y}^{- 1} ) \times ⌊ 2 cos ( ω r d ( 1 - y ) / 2 c ) \times ⌋ \\ \times {e}^{iω rd ( 1 - y ) / 2 c} ⌋\end{matrix} \qquad ( 8 )$$

Here it can be seen that the amplitude of the output signal is proportional to the difference in magnitudes of the two input signals, while the angle of the output signal is the angle of the sum of the unit vectors, which is equal to the average of the electrical angles of the two input signals.

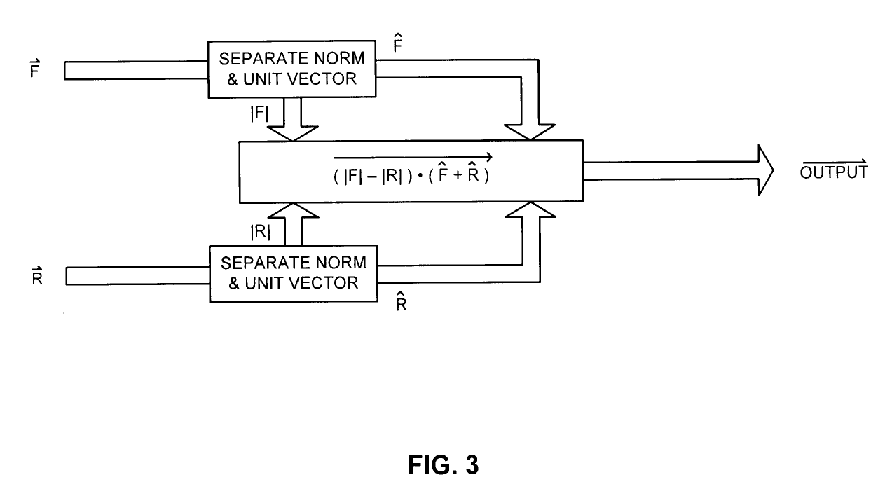

This signal processing performed in circuit 30 is shown in more detail in the block diagram corresponding of FIG. 3. Although it provides a noise reduction function, this form of the processing is not very intuitive into how the noise reduction actually occurs.

Dropping the common variables (ω,θ,d,r) for clarity and rearranging the terms of Equation 8 above gives,

$$\vec{O} ( ω , θ , d , r ) = \frac{{\vert {S}_{f} \vert}^{2} - {\vert {S}_{r} \vert}^{2}}{\vert {S}_{f} \vert \times \vert {S}_{r} \vert} \times ( \frac{\vert {S}_{f} \vert \times {\vec{S}}_{r}}{\vert {S}_{f} \vert + \vert {S}_{r} \vert} + \frac{\vert {S}_{r} \vert \times {\vec{S}}_{f}}{\vert {S}_{f} \vert + \vert {S}_{r} \vert} ) \qquad ( 9 )$$

where the arrows again represent vectors. With inspection, it can be seen that the frequency domain output signal for each frequency band is the product of two terms: the first term (the portion before the product sign) is a scalar value which is proportional to the attenuation of the signal. This attenuation is a function of the ratio of the norms of the two input signals and therefore is a function of the distance from the sound source to the array. The second term of Equation (9) (the portion after the product sign) is an average of the two input signals, where each is first normalized to have a magnitude equal to one-half the harmonic mean of the two separate signal magnitudes. This calculation creates an intermediate signal vector that has the optimum reduction for any set of independent random noise components in the input signals. The calculation then attenuates that intermediate signal according to a measure of the distance to the sound source by multiplication of the intermediate signal vector by scalar value of the first term.

Note that this processing is “instantaneous”, in other words it does not rely upon any prior information from earlier time frames—therefore it does not suffer from adaptation delay. It should be clarified that in these discussions, the variable X(ω,θ,d,r) below, is calculated as a ratio of the magnitudes when in the linear domain, and as the difference of the logarithms (usually expressed in dB) when in the log domain. Thus, X is described herein as a ratio when the discussion centers around a linear description, and as a difference when the discussion is about usage in the logarithmic domain. Although allowing insight into the noise reduction process, it is important when actually calculating the noise reduction process to be as efficient as possible for achieving high speed at low compute power. Thus, a more computationally efficient method of expressing these equations now will be discussed.

First, the ratio X(ω,θ,d,r) of the transformed short-time framed input signal magnitudes is obtained, where

$$X ( ω , θ , d , r ) = \sqrt{\frac{\begin{matrix}{\{ \text{Re} [ {\vec{S}}_{f} ( ω , θ , d , r ) ] \}}^{2} + \\ {\{ \text{Im} [ {\vec{S}}_{f} ( ω , θ , d , r ) ] \}}^{2}\end{matrix}}{\begin{matrix}{\{ \text{Re} [ {\vec{S}}_{r} ( ω , θ , d , r ) ] \}}^{2} + \\ {\{ \text{Im} [ {\vec{S}}_{r} ( ω , θ , d , r ) ] \}}^{2}\end{matrix}}} \qquad ( 10 )$$

Using this magnitude ratio and the original input signals, the output signal \vec{O}(ω,θ,d,r) is calculated as

\vec{O}(ω,θ,d,r)=[1−X(ω,θ,d,r)⁻¹]×\vec{S}_{f}(ω,θ,d,r)−[1−X(ω,θ,d,r)]×\vec{S}ᵣ(ω,θ,d,r) (11)

Note the minus sign in the middle of Equation (11). In the prior art approaches, direct summation of two independent NR equations helps to achieve greater directional far-field noise reduction than when either equation is used alone. In the present system, a single difference equation (11) is utilized without summation. The result is a unique, nearly non-directional near-field sensing system.

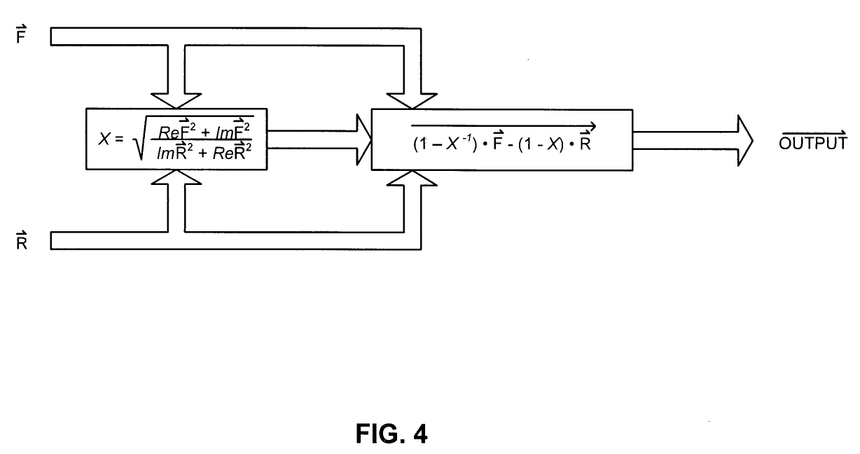

FIG. 4 is a block diagram of the signal processing portion of this direct equation method for creating the noise reduced output signal vector \vec{O}(ω,θ,d,r) from the two input signal vectors \vec{F}=(ω,θ,d,r) and \vec{R}=\vec{S}ᵣ(ω,θ,d,r).

Operation of this equation method is as follows:

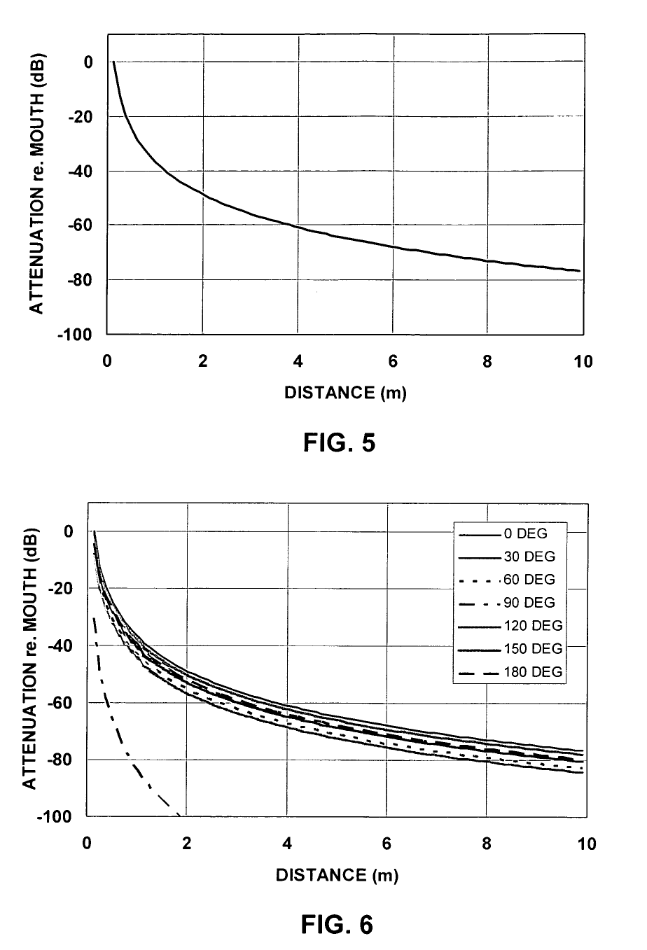

1) Assume that a noise source is located in the far-field. In this case, the magnitudes of the two input signals are virtually the same as each other due to 1/r signal spreading. When the magnitudes are the same, as in this situation, X is equal to “1” so both 1−X⁻¹ and 1−X are equal to zero. Thereby, according to equation (11) the output signal is virtually zero, and therefore far-field signals are greatly attenuated.
2) Assume that a voice signal originates on-axis with a signal magnitude difference of, for example, 3 dB. In this case, X≈1.4 so that 1−X⁻¹≈0.29 and 1−X≈−0.41. These values are in inverse proportion to the magnitude difference of the input signals. As these two values are applied in Equation (11), they have the effect of equalizing or normalizing the two input signals about a mean value. Thus, the output signal becomes the vector average of the two input signals after normalization. It is useful to note that the result is not a vector difference, as is used in gradient field sensing.
3) The double difference seen in equation (11) leads to a second-order slope in the attenuation vs. distance characteristic of the system. FIG. 5 shows the on-axis sensitivity relative to the mouth sensitivity vs. distance from the headset. Thus in FIG. 5, the mouth signal sensitivity is at the left end of the curve and at 0 dB. The amount below zero is proportional to the signal attenuation produced by the system, and is here plotted at frequencies of 300, 500, 1 k, 2 k, 3 k and 5 kHz. Clearly the frequency response is identical at all frequencies, since all the attenuation curves are identical (they all fall on top of one another). Identical frequency response is advantageous, since it prevents frequency response coloration of the signal as a function of distance, i.e. noise sources sound natural, although greatly attenuated. This second-order slope provides excellent noise attenuation performance of the system.

The attenuation slope is only slightly directional. Noise sources that are located at other angles with respect to the headset are equally or more greatly attenuated. FIG. 6 shows the attenuation response of the system at seven different arrival angles from 0° to 180° for a frequency of 1 kHz. It will be noted that the attenuation response is nearly identical at all angles, except for greater noise attenuation at 90°. This is due to a first-order “figure-8” (noise canceling) directionality pattern. The attenuation performance at all angles that are not on-axis exceeds that of the on-axis attenuation shown in FIG. 5.

4) The double difference displayed by Equation 11 also creates cancellation of any first-order frequency response characteristic (although not of the directionality) so that the overall frequency response is zeroth-order even though the directionality response is first-order. This means that the frequency response is “flat” when used with flat-response omni-directional microphones. In actuality, the frequency characteristic of the chosen microphone is preserved in the output without change or modification. This desirable characteristic not only provides excellent fidelity for the desired signal, but also eliminates the proximity effect seen with conventional directional microphone noise reduction systems.

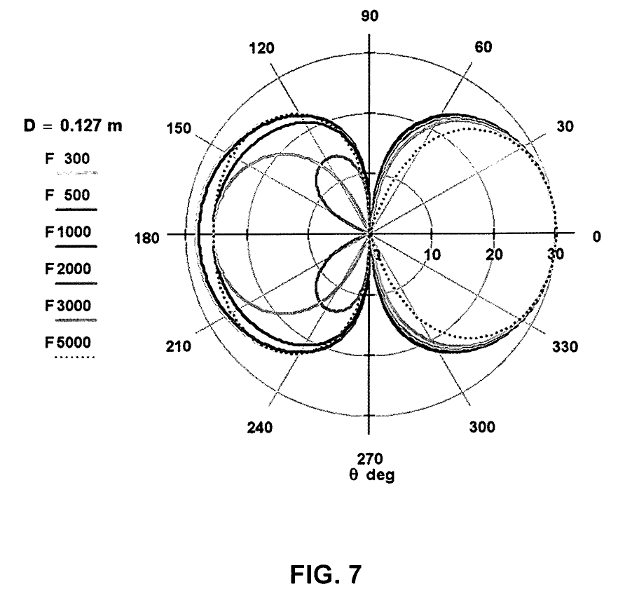

As just mentioned, the near-field sensitivity demonstrates the classical noise canceling “figure-8” directionality pattern. FIG. 7 is a plot of the directionality pattern of the system using two omni-directional microphones and measured at a source range of 0.13 m (5″), although remarkably this directionality pattern is essentially constant for any source distance. This is a typical range from the headset to the mouth, and therefore the directionality plot is demonstrative of the angular tolerance for headset misalignment. The array axis is in the 0° direction and is shown to the right in this plot. As can be seen, the signal sensitivity is within 3 dB over an alignment range of ±40 degrees from the array axis thereby providing excellent tolerance for headset misalignment. The directionality pattern is calculated for frequencies of 300, 500, 1 k, 2 k, 3 k, and 5 k Hz, which also demonstrates the excellent frequency insensitivity for sources at or near the array axis. This sensitivity constancy with frequency is termed a “flat” response, and is very desirable.

Since the frequency domain expression for each narrow-band input signal is a complex number representing a vector, the result of the described processing is to form an output complex number (i.e. vector) for each narrow-band frequency subsignal. When using Fourier techniques, it is common to refer to these individual frequency band signals as “bins”. Thus when combined, the output bin signals form an output Fourier transform representing the noise reduced output signal that may be used directly, inverse Fourier transformed to the time domain and then used digitally, or inverse transformed and subsequently D/A converted to form an analog time domain signal.

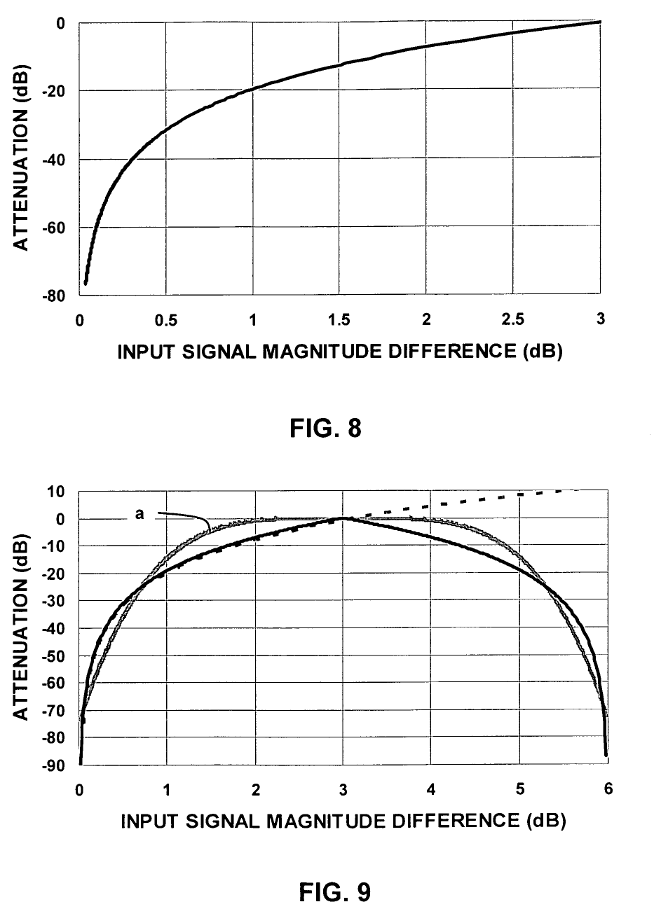

Another processing approach can also be applied. Fundamentally the effect of applying Equation (11) is to preserve, with little attenuation, the signal components from near-field sources while greatly attenuating the components from far-field sources. FIG. 8 shows the attenuation achieved by Equation (11) as a function of the magnitude difference between the front microphone (10) signal and the rear microphone (12) signal for the 3 dB design example described above. Note that little or no attenuation is applied to voice signals, i.e. where the magnitude ratio is at or near 3 dB. However, for far-field signals, i.e. signals that have an input signal magnitude difference very near zero, the attenuation is very large. Thus far-field noise source signals are highly attenuated while desired near-field source signals are preserved by the system.

Realizing that the effect of applying the above-described processing is similar to an attenuation process as just shown, a simpler approach to producing noise reduction performance can be discerned. Using the value of X(ω,θ,d,r), an attenuation value directly can be produced, and that attenuation value can then be applied to either input signal alone, or a combination of the two input signals (for example, their average value or the like). This approach streamlines and simplifies the calculations, and thereby reduces the consumed compute power. In turn, compute power savings translate into battery life improvements and size and cost savings.

The attenuation value that is to be applied can be derived from a look-up table or calculated in real-time with a simple function or by any other common means for creating one value given another value. Thus, only Equation (10) need be calculated in real time and the resulting value of X(ω,θ,d,r) becomes the look-up address or pointer to the pre-calculated attenuation table or is compared to a fixed limit value or the limit values contained in a look-up table. Alternatively, the value of X(ω,θ,d,r) becomes the value of the independent variable in an attenuation function. In general, such an attenuation function is simpler to calculate than is Equation (11) above.

It should be noted that the input signal intensity difference, X(ω,θ,d,r)² contains the same information as the input signal magnitude difference, X(ω,θ,d,r). Therefore the intensity difference can be used in this method, with suitable adjustment, in place of the magnitude difference. By using the intensity ratio, the compute power consumed by the square root operation in Equation (10) is saved and a more efficient implementation of the system process is achieved. Similarly, the power or energy difference or the like, can also be used in place of the magnitude difference, X(ω,θ,d,r).

In one implementation, the magnitude ratio between the front microphone signal and the rear microphone signal, X(ω,θ,d,r), is used directly, without offset correction, either as an address to a look-up table or as the value of the input variable to an attenuation function that is calculated during application of the process. If a table is used, it contains pre-computed values from the same or a similar attenuation function. The following will describe two examples of applicable functions. However, these are not the only possible useful attenuation functions, and any person knowledgeable in the art will understand that any such function falls within the scope of the invention.

As previously described, FIG. 8 shows the attenuation characteristic that is produced by the use of Equations (10) and (11). It might be concluded that creating the same characteristic instead by using this direct attenuation method would be desirable. This goal can be accomplished by applying the following function to directly compute the attenuation to be applied

$$attn ( ω , θ , d , r ) = {\{ 1 - \vert \frac{log ( X ( ω , θ , d , r ) )}{log ( X ( ω , θ , d , {r}_{m} ) )} - 1 \vert \}}^{2} \qquad ( 12 )$$

where rₘ is the distance to the desired or target source (in this case the user's mouth), wherein, per the above example, log(X(ω,θ, d,rₘ))=3 dB/20. As expected, the value of attn(ω,θ,d,r) ranges from 0 to 1 as the sound source moves closer—from a far away location to the location of the user's mouth. Without changing the range of attenuation, the shape of the attenuation characteristic provided by Equation (12) can be modified by changing the power from a square to another power, such as 1.5 or 3, which in effect modifies the attenuation from less aggressive to more aggressive noise reduction.

FIG. 9 shows the attenuation characteristic produced by Equation (12) as the solid curve, and for comparison, the attenuation characteristic produced by Equation (11) as the dashed curve. In this graph, the input signal magnitude difference scale is magnified to show the performance over 6 dB of signal difference range. As desired, the two attenuation characteristics are identical over the 0 to 3 dB input signal magnitude difference range. However, the attenuation characteristic created by Equation (11) continues to rise for input signal differences above 3 dB, while the characteristic created by Equation (12) is better behaved for such input signal differences and returns to zero for 6 dB differences. Thus, this method can create a better noise reduced output signal.

Of course, theoretically per the above example, there should never be differences above 3 dB, however from a practical stand-point, certain disturbances such as wind noise, microphonics and the statistical variability that occurs when taking short time measurements can create such signal differences. In no case will these be desired signals, so further attenuating them is beneficial.

FIG. 9 also shows, as curve a, another optional attenuation characteristic illustrative of how other attenuation curves can be applied. Curve a is the result of using the attenuation function

$$attn ( ω , θ , d , r ) = {2}^{- {\vert \frac{log ( X ( ω , θ , d , r ) ) - log ( X ( ω , θ , d , {r}_{m} ) )}{w} \vert}^{fl}} \qquad ( 13 )$$

where w is a parameter that controls the width of the attenuation characteristic, and fl is a parameter that controls the flatness of the top of the attenuation characteristic. Here the parameters were set to w=1.6 and fl=4, but other values also can be used. Further, attenuation thresholds as described below can be applied in this case as well.

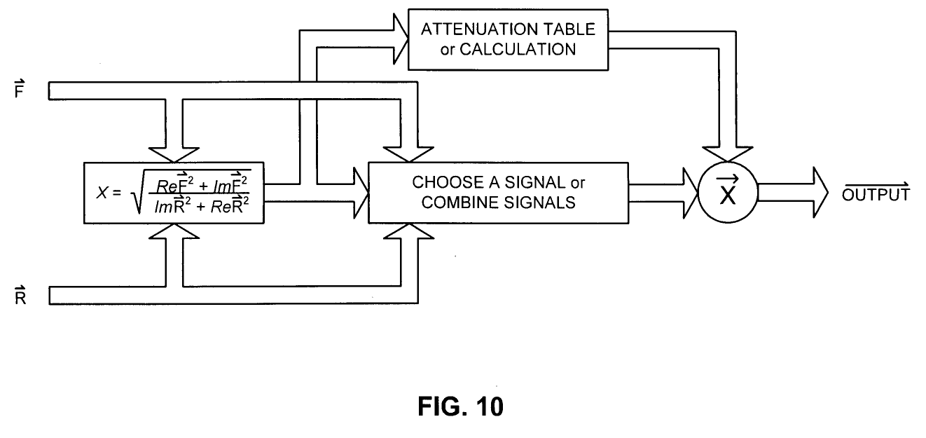

FIG. 10 shows a block diagram of how such an attenuation technique can be implemented to create the noise reduction process without the need for the real-time calculation of Equation (11).

At this point, it is instructive to point out that using STFT techniques with real world signals often does not produce ideal signals, but instead there are many reasons why some statistical variation will be present in the signals. Thus, there will be times when the value of X(ω,θ,d,r) exceeds a 3 dB difference as described above, and times when it is less than a 0 dB difference. In these cases, it can be assumed that the current signal is no longer the signal of interest, and that it can be completely attenuated. Thus, the attenuation can be modified by fully attenuating these extreme cases. The following equation accomplishes this additional full attenuation, but other methods can also be used without exceeding the scope of the invention.

$$attn ( ω , θ , d , r ) = \vert \begin{matrix}if X ( ω , θ , d , r ) < 1 , then 0 \\ if X ( ω , θ , d , r ) > X ( ω , θ , d , {r}_{m} ) , then 0 \\ else attn ( ω , θ , d , r )\end{matrix} \qquad ( 14 )$$

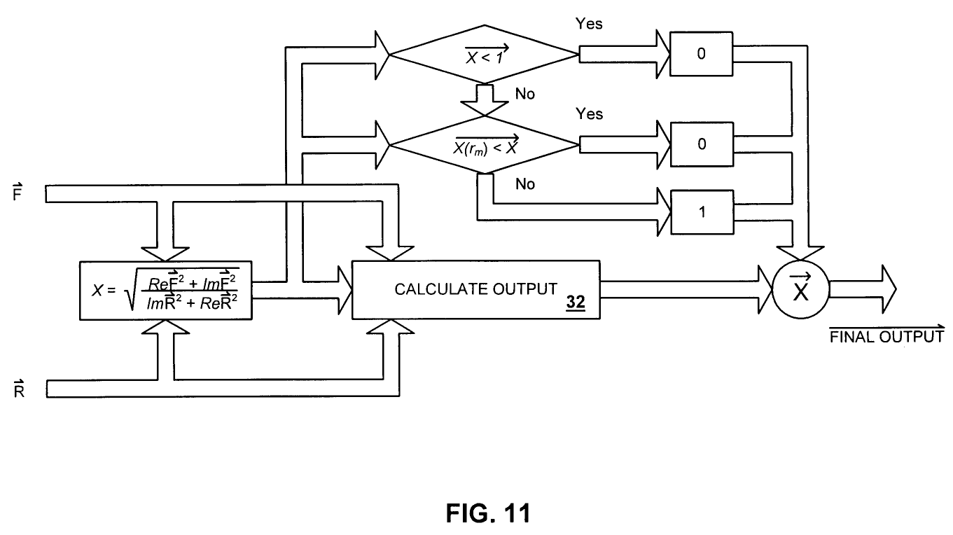

Equation (14) forces the output to be zero when the input signal magnitude difference is outside of the expected range. Other full-attenuation thresholds can be selected as desired by those of ordinary skill in the art. FIG. 11 shows a block diagram of this processing method that applies full attenuation to the output signal created in the processing box 32 “calculate output”. The output signal created in this block can use the calculation described for the approach above relating to Equation (11), for example.

A further and simpler attenuation function can be achieved by passing the selected signal when X(ω,θ,d,r) is within a range near to X(ω,θ,d,rₘ), and setting the output signal to zero when X(ω,θ,d,r) is outside that range—a simple “boxcar” attenuation applied to the signal to fully attenuate the signal when it is out of bounds. For example, in the graph shown in FIG. 9, for all input signal magnitude differences below 0 dB or above 6 dB, the output can be set to zero while those between can follow an attenuation characteristic such as those given above or simply be passed without attenuation. Thus, only desired and expected signals are passed to the output of the system.

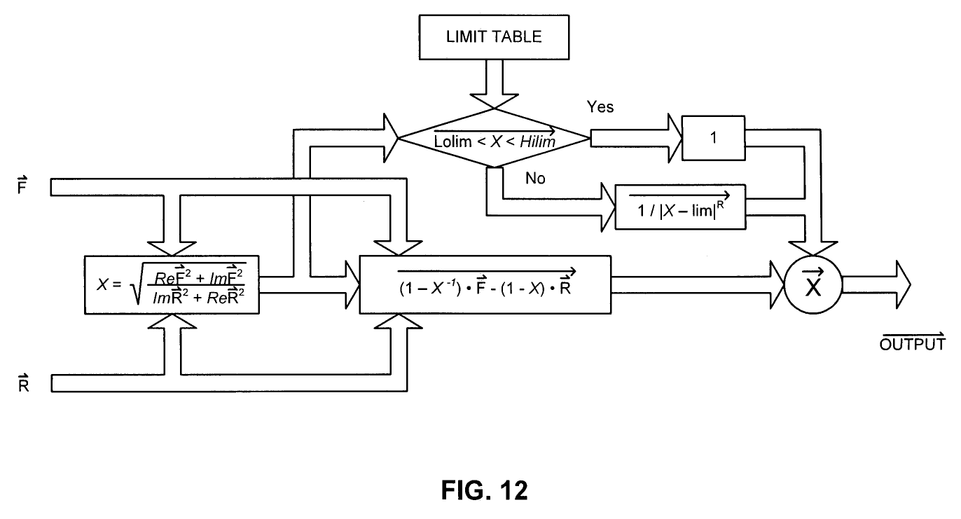

Another alternative is to compare the value of the input signal magnitude difference, X(ω,θ,d,r), to upper and lower limit values contained in a table of values indexed by frequency bin number. When the value of X(ω,θ,d,r) is between the two limit values, the selected input signal's value or the combined signal's value is used as the output value. When the value of X(ω,θ,d,r) is either above the upper limit value or below the lower limit value, the selected input signal's value or the combined signal's value is attenuated, either by setting the output to zero or by tapering the attenuation as a function of the amount that X(ω,θ,d,r) is outside the appropriate limit. One simple attenuation tapering method is to apply an attenuation amount calculated according to the following attenuation function

$$attn ( ω , θ , d , r ) = \frac{1}{{\vert X ( ω , θ , d , r ) - lim \vert}^{R}} \qquad ( 15 )$$

where R determines the rate of taper. If R=∞ (or practically, any very large number), then the attenuation is effectively set to zero when the signal difference is outside of the designated range as described in the previous paragraph. For lower values of the parameter R, the attenuation is more gradually tapered as the input signal magnitude difference exceeds either limit. FIG. 12 demonstrates a block diagram of this calculation method for limiting the output to expected signals. Here, the value of the input signal magnitude difference, X(ω,θ,d,r), is checked against a pair of limits, one pair per frequency bin, that have been pre-calculated and stored in a look-up table. Of course, alternatively, the limits can be calculated in real-time from an appropriate set of functions or equations at the expense of additional compute power consumption, but at the savings of memory utilization. Alternatively, the limit values can be a single fixed pair of values applied equally to all frequencies. If X is within the limits, then the calculated signal is passed to the output, whereas if the value of X is outside the limits, then the signal is attenuated, either completely (R=∞) or by a tapered attenuation.

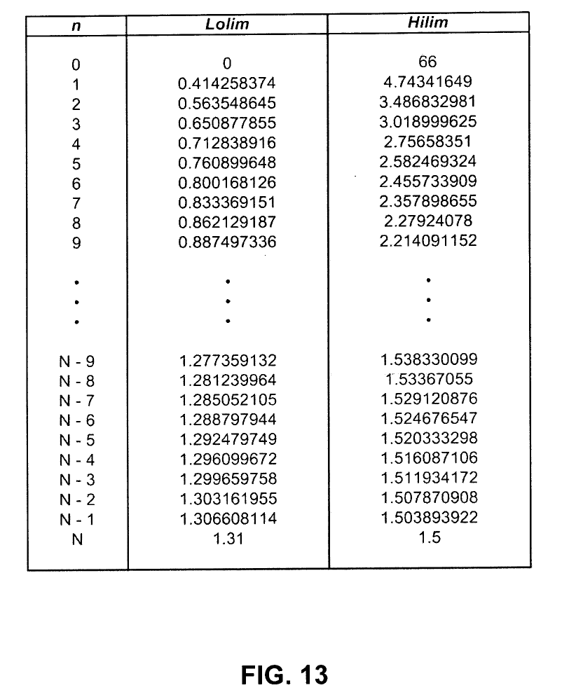

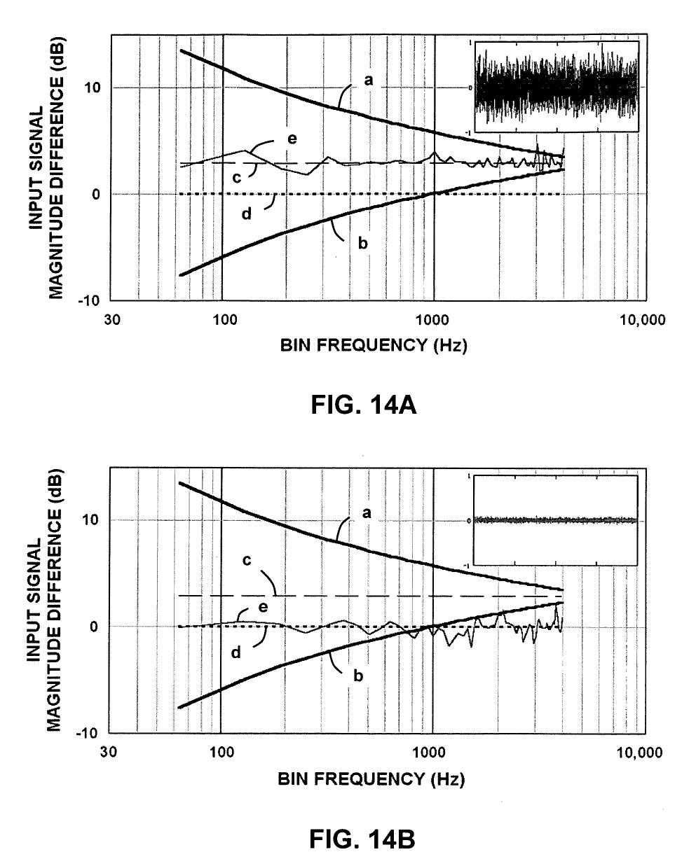

FIG. 13 is an example limit table calculated using the functions

$$\begin{matrix}W ( n ) = 1 + \frac{( 1 - q ) \times ( N - 1 - {log}_{2} ( n ) )}{q \times ( N - 1 )} & ( 16 ) \\ Lolim ( n ) = z \times W ( n ) and Hilim ( n ) = \frac{v}{W ( n )} & ( 17 )\end{matrix}$$

where n is the Fourier transform frequency bin number, N is the size of the DFT expressed as a power of 2 (the value used here was 7), q is a parameter that determines the frequency taper (here set to 3.16), z is a highest Lolim value (here set to 1.31) and v is a minimum Hilim value (here set to 1.5). FIGS. 14A and 14B show this set of limits plotted versus the bin frequency for a signal sample rate of 8 ksps.

In both graphs, the lines a and b show a plot of the limit values. The top line a plots the set of Hilim values and the bottom line b plots the set of Lolim values. The dashed line c is the expected locus of the target, or mouth, signal on these graphs while the dotted line d is the expected locus of the far-field noise.

In the FIG. 14A graph, line e is actual data from real acoustic measurements taken from the processing system, where the signal was pink-noise being reproduced by an artificial voice in a test manikin. The headset was on the manikin's right ear. It should be noted that the line e showing a plot of the input signal magnitude difference for this measured mouth data closely follows the dashed line c as expected, although there is some variation due to the statistical randomness of this signal and the use of the STFT. In the FIG. 14B graph, the pink-noise signal instead is being reproduced by a speaker located at a distance of 2-m from the mannequin. Again the line e showing a plot of the input signal magnitude difference for this measured noise data closely follows the dotted line, as expected, with some variation.

Using the attenuation principle explained above, signals falling outside of the “cone” delimited by lines a and b will be attenuated. Thus, it is easy to see that most of the noise, especially above 1000 Hz, will be attenuated while most of the voice signal will be passed to the output with little or no modification. In the upper right of each graph is shown the output signal as a function of time. For each measurement, the sound level was made identical at the headset, so the reduction in signal as seen in these time domain plots is due to the processing attenuation and not due to the 1/r effect.

Of course, there are many other tapering and limiting functions that can be applied instead of the functions shown as Equations (11), (12) and (13) and any such function is herein contemplated.

The attenuation function, or the attenuation function's coefficients, may be different for each frequency bin. Similarly, the limit values for full attenuation can be different for each frequency bin. Indeed, in a voice communications headset application it is beneficial to taper the attenuation characteristic and/or the full-attenuation thresholds so that the range of values of X(ω,θ,d,r) for which un-attenuated signal passes to the output becomes narrower, i.e. the attenuation becomes more aggressive for high frequencies, as demonstrated in FIGS. 14A and B.

In a second implementation, a reversal of the roles played by the difference in input signal magnitudes is involved. When it is possible to determine in advance what will be the difference in target signal levels at the microphones, prior to the processing, it then becomes possible to undo that level difference via a pre-computed and applied correction. After correcting the input signal magnitude difference for the target signal in this manner, the two input target signals become matched (i.e. the input signal magnitude difference will be 0 dB), but the signal magnitudes for far-field noise sources will no longer be matched.

This is different from matching transducer responses as described above. When transducer responses are matched, it means the each matched transducer will put out the same signal when placed in the same location and driven by the same complex acoustic input signal. Here, the matching occurs for the signals put out by each transducer, but when the transducers are in their separate (and different) locations where they each receive a different complex input signal. This type of matching is termed “signal matching”.

Signal matching for the target signal is easier to accomplish and may be more reliable, in part because the target signal is statistically more likely to be the largest input signal, making it easier to detect and use for matching purposes. This opens the door for applying continuous, automatic, real-time matching algorithms for simplicity of manufacture and reliable operation. Such matching algorithms utilize what is called a Voice Activity Detector (VAD) to determine when there is target signal available, and they then perform updates to the matching table or signal amplification value which may be applied digitally after A/D conversion or applied by controlling the preamp gain(s) for example to perform the match. During periods when the VAD output indicates that there is no target signal, then the prior matching coefficients are retained and used, but not updated. Often this update can occur at a very slow rate—minutes to days—since any signal drift is very slow, and this means that the computations for supporting such matching can be extremely low, consuming only a tiny fraction of additional compute power.

There are numerous prior art VAD systems disclosed in the literature. They range from simple detectors to more complicated detectors. Simple detection is often based upon sensing the magnitude, energy, power intensity or other instantaneous level characteristic of the signal and then basing the judgment whether there is voice by whether this characteristic is above some threshold value, either a fixed threshold or an adaptively modified threshold that tracks the average or other general level of the signal to accommodate slow changes in signal level. More complex VAD systems can use various signal statistics to determine the modulation of the signal in order to detect when the voice portion of the signal is active, or whether the signal is just noise at that instant.

If it is determined that the transducer signals effectively have the same frequency response and will not drift sufficiently to be a problem but differ primarily in signal strength, then matching can be as simple as designing the rear microphone preamplifier's gain to be higher by an amount that corrects for this signal strength imbalance. In the example described herein, that amount would be 3 dB. This same correction alternatively can be accomplished by setting the rear microphone's A/D scale to be more sensitive, or even in the digital domain by multiplying each A/D sample by a corrective amount. If it is determined that the frequency responses do not match, then amplifying the signal in the frequency domain after transformation can offer some advantage since each frequency band or bin can be amplified by a different matching value in order to correct the mismatch across frequency. Of course, alternatively, the front microphone's signal can be reduced or attenuated to achieve the match.

The amplification/attenuation values used for matching can be contained in, and read out as needed from, a matching table, or be computed in real-time. If a table is used, then the table values can be fixed, or regularly updated as required by matching algorithms as discussed above.

Once the strengths of the target signal portions of the input signals are matched, then either of the attenuation methods described above can be applied to process the signals for noise reduction, but where the input signal magnitude difference is first offset by the amount of the matching correction or the attenuation table values are offset by the amount of the matching correction.

For example, if the rear signal is amplified by 3 dB in order to effect a target signal match, then the input signal magnitude ratio X(ω,θd,rₘ)=1 (i.e. 0 dB) when there is target signal in the input, and X(ω,θ,d,r)=0.707 (i.e. −3 dB) when there is noise. To apply the attenuation of the first attenuation approach, X(ω,θ,d,r) is initially offset by the matching gain, in this case by 3 dB. Thus, X_{c}(ω,θ,d,r)=1.414×X(ω,θ,d,r) and X_{c}(ω,θ,d,rₘ)=1.414×X(ω,θ,d,rₘ) are used in the evaluation of Equation (12) to find the associated attenuation, where the subscript, c, denotes a corrected magnitude ratio.

### Wind Noise Resistance

Another noise component to be addressed in the design of any microphone pick-up system is wind noise. Wind noise is not really acoustic in nature, but rather is created by turbulence effects of air moving across the microphone's sound ports. Therefore, the wind noise at each port is effectively uncorrelated, whereas acoustic sounds are highly correlated.

Of the pressure gradient directional microphone types, omni-directional or zeroth-order microphones have the lowest wind noise sensitivity, and the system described herein exhibits zeroth-order characteristics. This makes the basic system as described above inherently wind noise tolerant.

However, the attenuation methods described subsequently are even better for rejecting wind noise. Since wind noise is uncorrelated at the ports of each microphone of the array, a statistically large portion of wind noise has an input signal magnitude difference, X(ω,θ,d,r), that is outside of the useful range for the acoustic signals. Since the useful range for acoustic signals in the headset example being used in this disclosure ranges from 0 dB to 3 dB, then other signal combinations that produce values for X(ω,θ,d,r) outside of the useful range will be automatically reduced to zero, thereby contributing to the output signal only when they happen to fall within the useful range. Statistically, this occurs very infrequently, with the result that wind noise is substantially reduced by the limiting effect of the processing described herein.

It can be useful to combine the approaches described above. For example, the output signal created using one approach described herein can be further noise reduced by subsequently applying a second approach described herein. One particularly useful combination is to apply the limit table approach of Equation 14 to the output signal of the Equation (11) approach. This combination is exemplified by the processing block diagram shown in FIG. 12.

### Alternative Uses

When one has a means for acquiring a clean signal in the presence of (substantial) noise, that means can be used as a component in a more complex system to achieve other goals. Using the described system and sensor array to produce clean voice signals means that these clean voice signals are available for other uses, as for example, the reference signal to a spectral subtraction system. If the original noisy signal, for example that from the front microphone, is sent to a spectral subtraction process along with the clean voice signal, then the clean voice portion can be accurately subtracted from the noisy signal, leaving only an accurate, instantaneous version of the noise itself. This noise-only signal can then be used in noise cancellation headphones or other NC systems to improve their operation. Similarly, if echo in a two-way communication system is a problem, then having a clean version of the echo signal alone will greatly improve the operation of echo cancellation techniques and systems.

A further application is for the clean pick-up of distant signals while ignoring and attenuating near-field signals. Here the far-field “noise” consists of the desired signal. Such a system is applicable in hearing aids, far-field microphone systems as used on the sideline at sporting events, astronomy and radio-astronomy when local electromagnetic sources interfere with viewing and measurements, TV/radio reporter interviewing, and other such uses.

Yet another use would be to combine multiple systems as described herein to achieve even better noise reduction by summing their outputs or even further squelching the output when the two signals are different. For example, two headset-style pickups as disclosed herein embedded and protected in a military helmet, where one is on each side or both on the same side, would allow excellent, reliable and redundant voice pickup in extreme noise conditions without the use of a boom microphone that is prone to damage and failure.

Thus although described for application in small, single-ear headsets, the system provides an approach for creating a high discrimination between near-field signals and far-field signals in any wave sensing application. It is efficient (low compute and battery power, small size, minimum number of sensor elements) yet effective (excellent functionality). The system consists of an array of sensors, high dynamic range, linear analog signal handling and digital or analog signal processing.

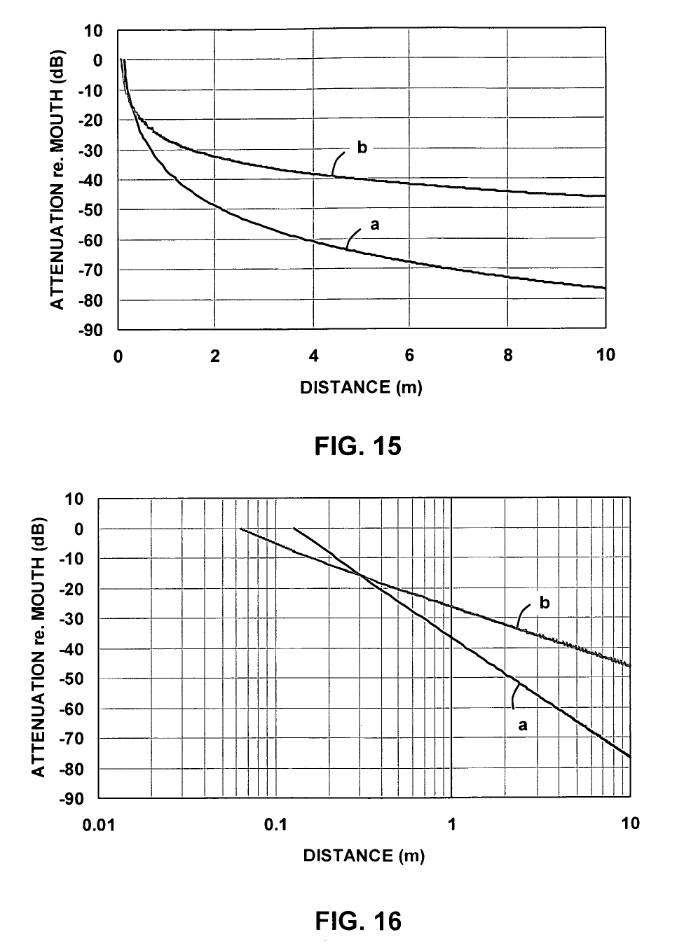

Illustrative of the performance, FIG. 15 shows a graph of the sensitivity as a function of the source distance away from the microphone array along the array axis. The lower curve (labeled a) is the attenuation performance of the example headset described above. Also plotted on this graph as the upper curve (labeled b) is the attenuation performance of a conventional high-end boom microphone using a first-order pressure gradient noise cancelling microphone located 1″ away from the edge of the mouth. This boom microphone configuration is considered by most audio technologists to be the best achievable voice pick-up system, and it is used in many extreme noise applications ranging from stage entertainment to aircraft and the military. Note that the system described herein out-performs the boom microphone over nearly all of the distance range, i.e. has lower noise pickup sensitivity.

FIG. 16 shows this same data, but plotted on a logarithmic distance axis. Here it can be seen that curve b corresponding to the conventional boom device starts further to the left because it is located closer to the user's mouth. Curve a corresponding to the performance of the system described herein starts further to the right, at a distance of approximately 0.13-m (5″), because this is the distance from the mouth back to the front microphone in the headset at the ear. Beyond the range of 0.3-m (1 ft), the signals from noise sources are significantly more attenuated by the system described herein than they are by the conventional boom microphone “gold standard”. Yet this performance is achieved with a microphone array located five times farther away from the source of the desired signal. This improved performance is due to the attenuation vs. distance slope which is twice that of the conventional device.

Advantages that thus may be realized include any or all of the following:
Zeroth-order flat target signal response—no proximity effect
Second-order far-field noise response—very rapid attenuation vs. distance
Wind noise insensitivity
Inherent reverberation and echo cancellation
Operation in negative SNR environments
High voice fidelity—for automatic speech recognition compatibility and hands-free quality
Very high noise reduction—in all noise conditions
Works with non-stationary as well as stationary noise—even impulsive sounds
“Instantaneously” adaptive—no adaptation delay
Compatible with other communication equipment and signal processes
Compact size—easily fits into commercial headsets—discrete
Low cost—minimum number of array elements & very compute efficient
Low battery drain—long battery life & fast battery recharge
Light weight
Alternate configurations, e.g. for far-field sensing, creating a VAD signal, etc.

The above are exemplary modes of carrying out the invention and are not intended to be limiting. It will be apparent to those of ordinary skill in the art that modifications thereto can be made without departure from the spirit and scope of the invention as set forth in the following claims.

1. A near-field sensing system comprising:
a detector array including a first detector configured to generate a first input signal in response to a stimulus and a second detector configured to generate a second input signal in response to the stimulus, the first and second detectors being separated by a separation distance d; and
a processor configured to generate an output signal from the first and second input signals, the output signal being a function of the difference of two values, the first value being a product of a first scalar multiplier and a vector representation of the first input signal and the second value being a product of a second scalar multiplier and a vector representation of the second input signal, wherein the first and second scalar multipliers each includes a term that is a function of a ratio of the magnitudes of the first and second input signals.

2. The system of claim 1, wherein the first scalar multiplier is defined by the relationship
1−X⁻¹
and the second scalar multiplier is defined by the relationship
1−X
where
X is the ratio of the magnitudes of the first and second input signals and is a function of the variables: ω, a radian frequency, θ, an effective angle of arrival of the stimulus relative to an axis connecting the two detectors, and r, a distance from the detector array to the stimulus.

3. The system of claim 1, wherein the first and second detectors are audio microphones.

4. A near-field sensing system comprising:
a detector array comprising a first detector configured to generate a first input signal in response to a stimulus and a second detector configured to generate a second input signal in response to the stimulus, the first and second detectors being separated by a separation distance d; and
a processor configured to generate an output signal representable by a vector having an amplitude that is proportional to a difference in magnitudes of the first and second input signals and having an angle that is the angle of the sum of unit vectors corresponding to the first and second input signals.

5. The system of claim 4, wherein the first and second detectors are audio microphones.

6. A near-field sensing system comprising:
a detector array comprising a first detector configured to generate a first input signal in response to a stimulus and a second detector configured to generate a second input signal in response to the stimulus, the first and second detectors being separated by a separation distance d; and
a processor configured to generate an output signal representable by an output vector that is attenuated in proportion to a distance r between the detector array and the stimulus such that attenuation increases with distance, the output vector being a function of the sum of the first and second input signals each normalized to have an amplitude equal to a mean of the amplitudes thereof.

7. The system of claim 6, wherein the output vector is a function of the sum of the first and second input signals each normalized to have an amplitude equal to the harmonic mean of the amplitudes thereof.

8. The system of claim 6, wherein the first and second detectors are audio microphones.

9. A near-field sensing system comprising:
a detector array comprising a first detector configured to generate a first input signal in response to a stimulus and a second detector configured to generate a second input signal in response to the stimulus, the first and second detectors being separated by a separation distance d; and
a processor configured to generate an output signal by combining the first and second input signals and attenuating said combination by an attenuation factor that is a function of the magnitudes of the first and second input signals.

10. The system of claim 9, wherein the first and second detectors are audio microphones.

11. The system of claim 9, wherein the function relates to a proportion used as an index to a look-up table from which said attenuation factor is obtained.

12. The system of claim 9, wherein said attenuation factor is obtained from a predetermined function.

13. A method for performing near-field sensing comprising:
generating, in response to a stimulus, first and second input signals from first and second detectors of a detector array, the first and second detectors being separated by a separation distance d; and
generating an output signal from the first and second input signals, the output signal being a function of the difference of two values, the first value being a product of a first scalar multiplier and a vector representation of the first input signal and the second value being a product of a second scalar multiplier and a vector representation of the second input signal, wherein the first and second scalar multipliers each includes a term that is a function of a ratio of the magnitudes of the first and second input signals.

14. The method of claim 13, wherein the first scalar multiplier is defined by the relationship
1−X⁻¹
and the second scalar multiplier is defined by the relationship
1−X
where
X is the ratio of the magnitudes of the first and second input signals and is a function of the variables: ω, a radian frequency, θ, an effective angle of arrival of the stimulus relative to an axis connecting the two detectors, and r, a distance from the detector array to the stimulus.

15. The method of claim 13, wherein the first and second detectors are audio microphones.

16. A method for performing near-field sensing comprising:
generating, in response to a stimulus, first and second input signals from first and second detectors of a detector array, the first and second detectors being separated by a separation distance d; and
generating an output signal from the first and second input signals, the output signal being representable by a vector having an amplitude that is proportional to a difference in magnitudes of the first and second input signals and having an angle that is the angle of the sum of unit vectors corresponding to the first and second input signals.

17. The method of claim 16, wherein the first and second detectors are audio microphones.

18. A method for performing near-field sensing comprising:
generating, in response to a stimulus, first and second input signals from first and second detectors of a detector array, the first and second detectors being separated by a separation distance d; and
generating an output signal representable by an output vector that is attenuated in proportion to a distance r between the detector array and the stimulus such that attenuation increases with distance, the output vector being a function of the average of the first and second input signals each normalized to have an amplitude equal to a mean of the amplitudes thereof.

19. The method of claim 18, wherein the output vector is a function of the average of the first and second input signals each normalized to have an amplitude equal to the harmonic mean of the amplitudes thereof.

20. The method of claim 18, wherein the first and second detectors are audio microphones.

21. A method for performing near-field sensing comprising:
generating, in response to a stimulus, first and second input signals from first and second detectors of a detector array, the first and second detectors being separated by a separation distance d; and
generating an output signal by combining the first and second input signals and attenuating said combination by an attenuation factor that is a function of the magnitudes of the first and second input signals.

22. The method of claim 21, wherein the first and second detectors are audio microphones.

23. The method of claim 21, wherein the function relates to a proportion used as an index to a look-up table from which said attenuation factor is obtained.

24. The method of claim 21, wherein said attenuation factor is obtained from a predetermined function.
